(19) United States
(12) Patent Application Publication
(10) Pub. No.: US 2018/0331465 A1
(43) Pub. Date: Nov. 15, 2018

(54) POWER PLUG WITH LEAKAGE CURRENT PROTECTION DEVICE

(71) Applicant: Chengli LI, Suzhou (CN)

(72) Inventors: Chengli LI, Suzhou (CN); Shengyun NIE, Suzhou (CN)

(73) Assignee: Chengli LI, Suzhou (CN)

(21) Appl. No.: 15/847,896

(22) Filed: Dec. 19, 2017

Related U.S. Application Data
(63) Continuation-in-part of application No. 15/592,674, filed on May 11, 2017.

(30) Foreign Application Priority Data
Dec. 8, 2017 (CN) 201711294238.X
Dec. 8, 2017 (CN) 201721700251.6

(51) Int. Cl. H01R 13/533; H01R 11/07; H01R 13/629; H01R 13/627

(52) U.S. Cl. CPC H01R 13/533; H01R 13/6275; H01R 13/62916; H01R 11/07

(57) ABSTRACT

A power plug with leakage current protection device, which includes a body formed of an upper cover and a base, a core assembly disposed in the body, a cable assembly attached to the body, a plurality of input insertion plates and output moving contact arms which are assembled with the core assembly, and an insertion plate sleeve disposed on the base, where the input insertion plates pass through the insertion plate sleeve to protrude from the base. The insertion plate sleeve is made of an insulating and temperature resistant material. The power plug has a simple overall structure and can be assembled easily and reliably. It can prevent the safety risk caused by high temperature of the input insertion plates without increasing the size of the plug. It also has low cost, and can be suitably employed in various types of power plugs.

### BACKGROUND OF THE INVENTION

### Field of the Invention

This invention relates to electrical appliances, and in particular, it relates to a power plug for electrical appliances that incorporates a leakage current protection device.

### Description of Related Art

With the wide use of home electrical appliances, their safety is an important issue. Current electrical appliances typically have a power plug that incorporates a leakage current protection device. However, current power plugs with leakage current protection devices still have certain problems affecting their safety. For example, when the insertion plates of the power plug have a bad connection, or when the spring force that maintains the tight contact between the insertion plates and the conductors of the power receptacle deteriorate due to long-time use, the electrical resistance associated with the insertion plates may increase. This can cause the temperature of the insertion plates to increase, which can deform the plastic body of the plug near the insertion plates, or even cause fire. This can be a serious safety threat.

### SUMMARY

To solve the above described problem, embodiments of the present invention provides an improved power plug with leakage current protection device, which is equipped with a protection piece made of an insulating material with high temperature resistance, located near where the insertion plates are connected to the body of the power plug. This can prevent the plug body from melting due to the high temperature of the insertion plates, and ensure the normal operation of the plug.

In one embodiment, the present invention provides a power plug with leakage current protection device, which includes: a body formed of an upper cover and a base; a core assembly disposed in the body; a cable assembly attached to the body; a plurality of input insertion plates; a plurality of output moving contact arms; wherein the plurality of input insertion plates and the plurality of output moving contact arms are assembled with the core assembly; and an insertion plate sleeve disposed on the base, wherein the input insertion plates pass through the insertion plate sleeve to protrude from the base, and wherein the insertion plate sleeve is made of an insulating and temperature resistant material.

The invention includes the following preferred embodiments.

In some embodiments, the insertion plate sleeve includes a number of parts corresponding to a number of the input insertion plates, wherein each part includes a hole for accommodating one input insertion plate that passes through the hole, and wherein the insertion plate sleeve further includes an assembly base which is connected to the base of the body.

In some embodiments, the hole of each of the parts is a sleeve that protrudes upwards from a bottom of the assembly base.

In some embodiments, the insertion plate sleeve is formed integrally as one piece.

In some embodiments, the base of the body defines an opening, and wherein the insertion plate sleeve is disposed in the opening and the assembly base of the insertion plate sleeve is connected to the base of the body via snaps.

In some embodiments, the insertion plate sleeve is formed of engineering plastics, ceramics, or fiber glass.

In some embodiments, the insertion plate sleeve includes a number of parts corresponding to a number of the input insertion plates, the number of parts being separate from each other, wherein each part includes an assembly base which is connected to the base of the body and a hole for accommodating one input insertion plate that passes through the hole.

In some embodiments, the hole of each of the parts is a sleeve that protrudes upwards from a bottom of the corresponding assembly base.

In some embodiments, the base of the body defines a number of openings corresponding to the number of the input insertion plates, and wherein each of the separate parts is disposed in a corresponding opening and the assembly base of the part is connected to the base of the body via snaps.

The power plug with leakage current projection device according to embodiments of the present invention can effectively prevent safety risk caused by high temperature of the insertion plates, is reliable, has a simple structure, and is easy to implement. Compared to a design that uses an insulating material for the entire plug body, the power plug according to embodiments of the present invention is more cost effective.

### BRIEF DESCRIPTION OF THE DRAWINGS

Other characteristics and advantages of the present invention are described in various embodiments with reference to the following drawings.

FIG. 1 is an exterior view of a power plug with leakage current protection device according to an embodiment of the present invention.

FIG. 2 is an exploded view of the power plug of FIG. 1, viewed from the bottom, where an insertion plate sleeve is connected to the base.

FIG. 3 is an exploded view showing the core assembly and the input insertion plates.

FIG. 4 is an assembled view showing the core assembly and the input insertion plates.

FIG. 5 is an exploded view of the power plug of FIG. 1, viewed from the top, showing the insertion plate sleeve separated from the other components.

FIG. 6 is an exploded view of a portion of the power plug of FIG. 5, viewed from the bottom.

FIG. 7 is an exploded view of a power plug according to another embodiment, in a view similar to FIG. 5.

FIG. 8 is an exploded view of a portion of the power plug of FIG. 7, viewed from the bottom.

### DETAILED DESCRIPTION OF PREFERRED EMBODIMENTS

Embodiments of the present invention and their operation are described in detail below. It should be understood that the embodiments described here serve to illustrate the implementations and operation of the invention, and do not limit the scope of the invention. The directional expressions such as up, down, top, bottom, etc. that are used in the descriptions are relative and not absolute. When the various components are disposed in the illustrated manner, these directional expressions are appropriate; when the arrangements of the components change, the directional expressions may change accordingly.

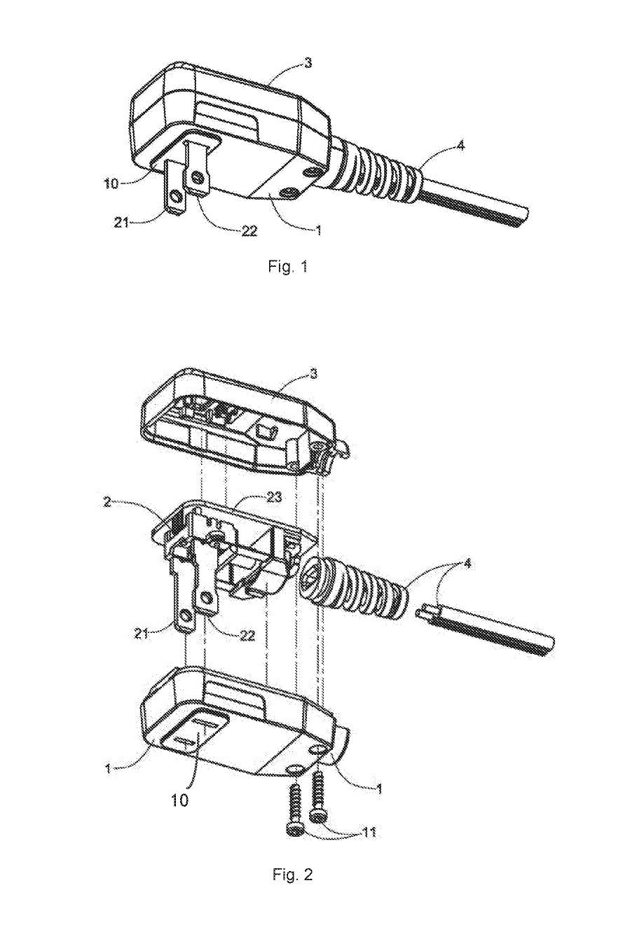

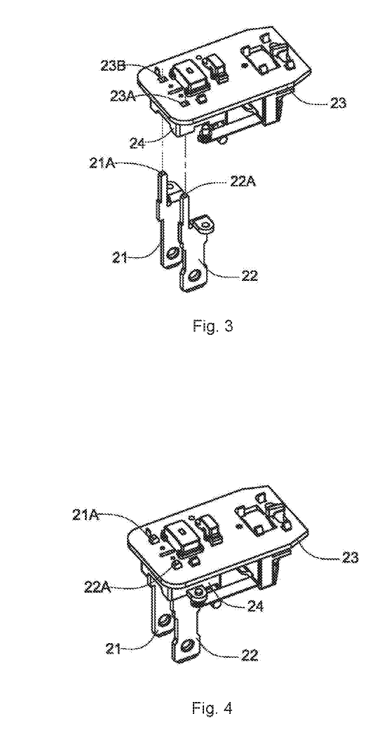

Refer to FIGS. 1-6, which illustrate a power plug with leakage current protection device according to a preferred embodiment of the present invention. The power plug includes a body formed by an upper cover 3 and a base 1. A core assembly 2 and a cable assembly 4 are disposed in the body. The core assembly 2 includes a printed circuit board 23 and a detection assembly and a trip assembly disposed on the printed circuit board 23. Input insertion plates 21, 22 and output moving contact arms are respectively assembled with the core assembly 2. As shown in FIGS. 3 and 4, the input insertion plates 21, 22 are supported by and fixed on an insertion plate support frame 24, and the soldering ends 21A, 22A of the input insertion plates 21, 22 pass through solder plate holes 23B, 23A of the printed circuit board 23 and soldered on the printed circuit board 23, to establish reliable electrical connection. The cable assembly 4 includes an electrical cable and a cable release that covers the cable. The cable release is fixed by a slot formed on the upper cover 3 and the base 1, to provide bending resistance for the cable. Further, a reset button and a test button are disposed between the upper cover 3 and the core assembly 2. After the various components inside the body are assembled, the upper cover 3 and the base 1 are aligned to each other via snaps on these two components, and fastened together using fastening components such as screws.

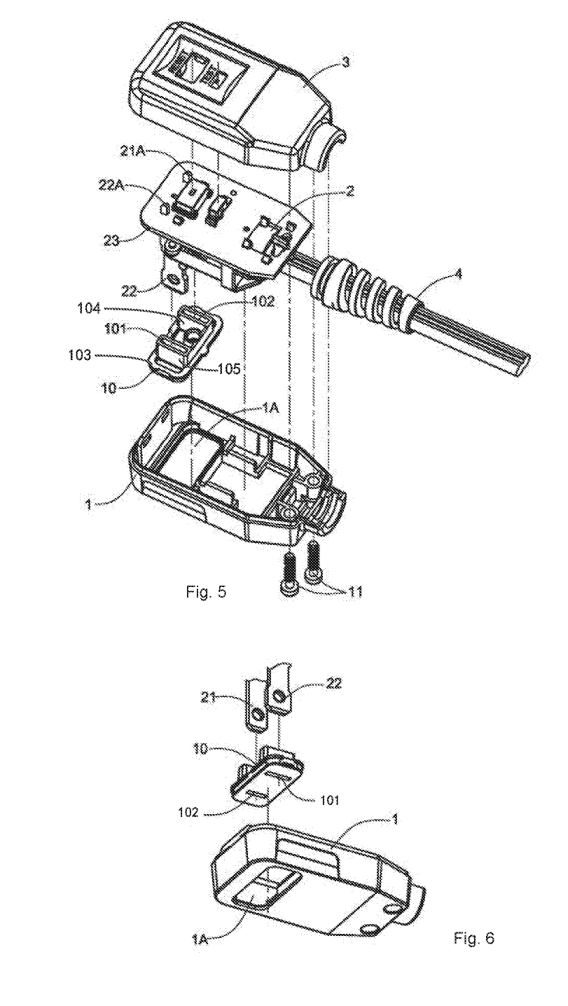

According to embodiments of the present invention, the power plug further includes an insertion plate sleeve disposed on the base 1, such that the input insertion plates pass through the insertion plate sleeve to protrude from the base. The insertion plate sleeve is made of an insulating and high temperature resistant material, for example, materials that will not deform or melt at temperatures from about 110 degrees C. to hundreds of degrees C. In comparison, the body (base and upper cover) is made of a lower cost plastic material that may start to deform or melt at temperatures below about 110 degrees C. Advantageously, the insertion plate sleeve includes a number of parts corresponding to the number of the input insertion plates. For example, in the embodiment shown in FIGS. 5 and 6, the insertion plate sleeve 10 includes two parts 101 and 102 which are formed integrally as one piece, and the parts 101, 102 respectively correspond to the two input insertion plates 21, 22. More specifically, the insertion plate sleeve 10 includes an assembly base 103 formed around the bottom of the parts 101, 102, and holes 104, 105 for respectively accommodating the input insertion plates 21, 22 that pass through them. The assembly base 103 has a connection structure such as hooks and/or snaps, which engages a corresponding connection structure such as snaps and/or hooks located around an opening 1A of the base 1. It should be understood that the number of hooks or snaps on the assembly base and the base may be one or more. These connection structures can ensure high assembly quality and reduce assembling time.

In this embodiment, the holes 104, 105 of parts 101, 102 can be formed by sleeves that protrude upwards from the bottom of the assembly base, which can precisely position and securely hold the input ends of the input insertion plates 21, 22. In particular, the sleeves can extend to the base of the input insertion plates 21, 22 close to the insertion plate support frame 24. This can prevent the risk caused by high temperature of the input insertion plates. It should be understood that holes of other shapes may also be used.

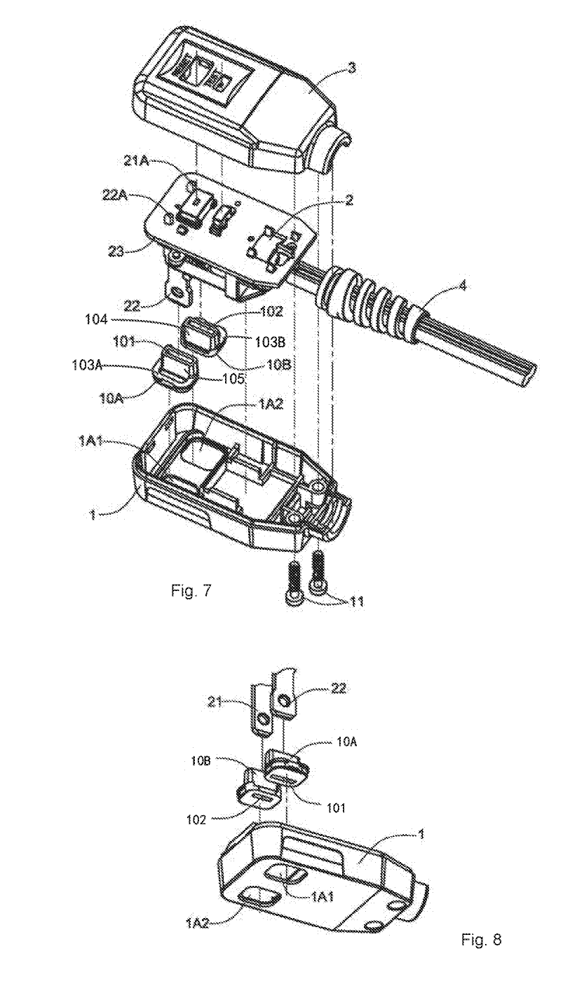

FIGS. 7 and 8 illustrate a power plug with leakage current protection device according to another embodiment. In this embodiment, the insertion plate sleeve similarly includes a number of parts corresponding to the number of input insertion plates 21, 22; a difference between this embodiment and the first embodiment is that here the two pats 101 and 103 are separate parts which form two individual and separate insertion plate sleeves 10A, 10B. The insertion plate sleeve 10A includes an assembly base 103A formed around the bottom of the part 101 and a hole 105 for accommodating the input insertion plate 22 that passes through it. Likewise, the insertion plate sleeve 10B includes an assembly base 103B formed around the bottom of the part 102 and a hole 104 for accommodating the input insertion plate 21 that passes through it. Correspondingly, the base 1 has two openings 1A1, 1A2 which respectively cooperate with and connect with the insertion plate sleeves 10A, 10B, for example via hooks and snaps.

It should be understood that the embodiments illustrated in FIGS. 1-8 only show and label the main components of constituent parts of the power plug of the present invention. The shape and arrangements of the components and parts are illustrative only and not limiting. The power plug may employ components and parts having other shapes and sizes without departing from the spirit of the invention. Further, the insertion plate sleeves of the various embodiments can be made of suitable insulating and temperature resistant materials which may be selected based on the temperature environments of the power plug. The suitable materials be, without limitation, engineering plastics, ceramics, fiber glass, etc.

The power plug with leakage current projection device according to embodiments of the present invention has a simple overall structure, and can be reliably assembled. It can effectively prevent safety risk caused by high temperature of the insertion plates, without increasing the assembled size of the power plug. It also has low cost, and can be suitably employed in various types of power plugs.

It will be apparent to those skilled in the art that various modification and variations can be made in the power plug of the present invention without departing from the spirit or scope of the invention. Thus, it is intended that the present invention cover modifications and variations that come within the scope of the appended claims and their equivalents.

What is claimed is:

1. A power plug with leakage current protection device, comprising:
a body formed of an upper cover and a base;
a core assembly disposed in the body;
a cable assembly attached to the body;
a plurality of input insertion plates;
a plurality of output moving contact arms;
wherein the plurality of input insertion plates and the plurality of output moving contact arms are assembled with the core assembly; and
an insertion plate sleeve disposed on the base, wherein the input insertion plates pass through the insertion plate sleeve to protrude from the base, and wherein the insertion plate sleeve is made of an insulating and temperature resistant material.

2. The power plug of claim 1, wherein the insertion plate sleeve includes a number of parts corresponding to a number of the input insertion plates, wherein each part includes a hole for accommodating one input insertion plate that passes through the hole, and wherein the insertion plate sleeve further includes an assembly base which is connected to the base of the body.

3. The power plug of claim 2, wherein the hole of each of the parts is a sleeve that protrudes upwards from a bottom of the assembly base.

4. The power plug of claim 3, wherein the insertion plate sleeve is formed integrally as one piece.

5. The power plug of claim 1, wherein the base of the body defines an opening, and wherein the insertion plate sleeve is disposed in the opening and the assembly base of the insertion plate sleeve is connected to the base of the body via snaps.

6. The power plug of claim 1, wherein the insertion plate sleeve is formed of engineering plastics, ceramics, or fiber glass.

7. The power plug of claim 1, wherein the insertion plate sleeve includes a number of parts corresponding to a number of the input insertion plates, the number of parts being separate from each other, wherein each part includes an assembly base which is connected to the base of the body and a hole for accommodating one input insertion plate that passes through the hole.

8. The power plug of claim 7, wherein the hole of each of the parts is a sleeve that protrudes upwards from a bottom of the corresponding assembly base.

9. The power plug of claim 8, wherein the base of the body defines a number of openings corresponding to the number of the input insertion plates, and wherein each of the separate parts is disposed in a corresponding opening and the assembly base of the part is connected to the base of the body via snaps.
